(19) United States
(12) Patent Application Publication
(10) Pub. No.: US 2014/0207113 A1
(43) Pub. Date: Jul. 24, 2014

(54) METHOD, ASSEMBLIES AND DEVICES FOR NUTRIENT DELIVERY

(71) Applicant: Bjornar Sjursen, Horten (NO)

(72) Inventor: Bjornar Sjursen, Horten (NO)

(21) Appl. No.: 14/127,834

(22) PCT Filed: Jun. 26, 2012
(86) PCT No.: PCT/EP2012/062332

§ 371 Date: Jan. 27, 2014

(30) Foreign Application Priority Data
Jun. 27, 2011 (NO) 20110919

(51) Int. Cl. A61J 15/00

(52) U.S. Cl. CPC A61J 15/0096; A61J 15/0026
USPC 604/518; 604/123; 604/500; 604/152

(57) ABSTRACT

The invention concerns an assembly for delivering a flowable nutritional substance, e.g. made from homemade cooked foods or home prepared food or foods treated with a hand blender or equivalent, comprising a substantially tubular container 1 formed with enclosed lower end and an open upper end, the open upper end being adapted to receive in a sealing manner a closure 20, the closure comprising a unidirectional valve 18, the container 1 also comprising a fluid outlet port in the form of a valve and a pump mechanism 3 is contained in a pump housing 5.

### The invention relates to the delivery of nutrients. More particularly, the invention relates to methods, assemblies and devices for assisted nutrient delivery.

### BACKGROUND

Based on global research there has been an increasing trend in the numbers of people with different forms of nutrition medical conditions requiring the supply of nutrition through a tube down the esophagus, nasogastric or gastrostomy connected to a gastrostomiport or PEG (Percutaneous Endoscopic Gastrostomy) or feeding tube into the stomach, collectively covered by the term enteral feeding. As result of the numbers of users increasing and an increasing awareness about allergies and natural and varied nutrition there are new requirements connected to nutrition stoma. The new needs can roughly be separated into two areas; 1) firstly there is a need for aesthetical and low stigmatising solutions connected to pumps and other types of equipment, 2) secondly there is need for solutions which makes it possible to use homemade food in nutrition stoma in a practical, secure and aesthetically appealing way.

Today's solutions are based on standard nutrition solutions and dosage pumps following the pattern of the infusion pumps. These solutions have improved in recent years. They are smaller, lighter and quieter. Some which are still significantly the same are the medical design stigmatising bags with a nutritional solution mix. The solution on the market does not include one for the dinning situation with nutrition solutions largely in the form of a hanging bag and designs from the health sector. Intolerance of, and allergies connected to, different ingredients in industrially made nutrition mix is becoming more widespread.

The mentioned typical nutrition solutions do not allow for the use of homemade food in the PEG. Generally it is not possible to distribute non industrial processed food using the mentioned solutions, because its consistency is not even or thin enough and it consists of lumps of different sizes. Particularly for parents to children with PEG there is a greater wish to be more active in the process of choosing the nutrition and health option for their children. Participation and active choices in connection with nutrition is fundamentally anchored in us as humans. This is especially clear in connection with smaller children and children having disabilities for example cerebral palsy. In the user groups we also find active and health conscious people who want control over their own nutrition. Low influence over food raw materials and content combined with having to use soft bags (reminiscent of infusion bags) filled with nutrition having thin consistency contributes to an association with, and labeling of, disease by the user. In connection with meals in a restaurant, or for a child in a school, the existing solutions are challenging for the user.

Typical solutions make it hard to customise nutrition to a single user taking into account special dietary needs, particular food intolerances and/or allergies. In addition to the abovementioned problems there are large costs involved with nutritional solutions which are industrially made and have to be bought by the user so that they can eat the same foods as other family members or out of the home environment and at an institution.

The patent specification WO2008/098190A1 describes systems, devices and methods for enteral feeding that, in some arrangements, are powered by energy produced by a user of the system. Other arrangements utilise an external peristaltic pump. Generally, the systems include a storage assembly configured to hold a nutritional substance to be delivered to the gastrointestinal system of a user, such as through a feeding tube. The systems may include a pump unit, which can be manual, mechanical, hydraulic or electric. In some arrangements, the pump unit is separate from the storage assembly. The system for delivering food gastrostomies may include a feed container for the mixing of a nutrient solution. However, it is suggested that the system described in WO2008/098190 cannot be used for participation in a common meal environment where the food is prepared at the table using hand operated mixing tools, because it is generally only suitable for nutrition mixture without lager particles similar to the common size of a mixture resulting from the use of a hand mixer, grinding mill or a blender. Also, the system does not allow for the mixture within the storage assemble to be added to, or be replenish, during the process of delivering the nutrition to the user.

There is therefore a need for improvement in relation to the typical nutrition delivery systems and apparatus.

### SUMMARY

The invention is therefore directed towards solving at least some of the above mentioned problems associated with nutrition delivery.

One aspect of the present invention is the realisation by the inventor of the drawbacks associated with the prior art devices particularly the drawback related to those devices which do not allow for the re-filling of the device and particularly the filling of the device during the delivery process of the nutrient.

In addition another aspect of the present invention is to provide assembly, method and device whereby the preparation of the nutritional material suitable for delivery to the user is capable of being carried out at the location of the nutrition delivery. Another benefit of the invention is there is provided an assembly which may deliver nutrition made from homemade cooked foods or home prepared food or foods treated with a hand blender or equivalent and also including beverages and industrially produced food.

According to a first aspect of the present invention there is provided an assembly for delivering a flowable nutritional substance to a delivery tube, the system comprising a container, a closure for the container and a pump, wherein the closure comprises a unidirectional valve for purging fluid from the container, the container comprising an outlet for a nutritional substance and the assembly being arranged such that in use the pump is configured to transfer the nutritional substance from the container to the delivery tube via the outlet.

Preferably, the unidirectional valve has an operative condition, such that in the operative condition fluid is only passable through the valve in a directional flow from inside the container to outside the container. The use of the unidirectional valve means that fluid, such as unwanted air within the container, may be purged from the container.

Also it is preferable that the unidirectional valve has an inoperative condition such that in said inoperative condition fluid may flow in both directions into and out of the container. The inoperative condition may be achieved by providing means to partially or substantially open the valve in the closure. The partially or substantially removal of the closure with the valve will provide access to the inner parts of the container whereby the container may be filled with a substance or material.

In an alternative embodiment of the first aspect of the present invention the unidirectional valve for purging fluid from the container is formed in the container wall or received by a port formed in the container wall.

The container is preferably formed with an open end and the closure being adapted to be received by the open end. It is preferable that in use the closure forms a sealable contact with an inner surface of the container when it is received by the open end. The sealable contact helps to ensure that any nutritional substance remains within the container until it is transferred from the container by the pump.

According to a second aspect of the invention there is provided an assembly for delivering a flowable nutritional substance to a delivery tube, the system comprising a container, a closure for the container and a pump, the container comprises an outlet for a nutritional substance and the assembly being arranged such that in use the pump is configured to transfer the nutritional substance from the container to the delivery tube via the outlet, wherein the closure is a movable piston being capable of slidable contact with a surface of the container. The closure preferably comprises an annular seal feature that is in slidable contact with the inner surface of the container. The annular seal is preferably formed by a flexible radially outer rim.

Preferably the system is such that in use the closure moves relative to the container surface in response to a pressure difference between an outer portion of the closure and an inner portion of the closure. Preferably the pressure difference experienced by the closure is generated by the pump transferring the nutritional substance from the container. Preferably the movement of the closure is in a direction towards the outlet for the nutritional substance. Preferably the movement of the closure is in a direction towards the pump. Preferably in use the movement of the closure is in a direction away from the open end of the container. Preferably the movement of the closure is in a direction substantially downward towards a surface supporting at least one of the container, the closure and/or pump unit rest.

According to a third aspect of the present invention there is provided an assembly according to the first and/or second aspect of the invention and comprising means for filtering the nutritional substance prior to the substance entering the delivery tube. The filtering means preferably comprises at least one flow restriction formed to prevent passage of particles of a predetermined size and allow passage of other matter preferably formed from particles of sizes lesser than the predetermined size. Most preferably the filter means comprises a plurality of flow restrictions formed by a number of orifices and/or being formed by a mesh structure.

The orifices and/or mesh structure preferably have an opening size of greater than or equal to 1 mm. Preferably orifices and/or mesh structure have an opening size of less than or equal to 4 mm. Preferably the orifices and/or mesh structure have an opening size in the range of 1 mm to 4 mm (inclusive). The filtering means is preferably disposed in the flow path of the outlet of the container and more preferably the filtering means is disposed adjacent the outlet of the container.

According to one embodiment of the present invention the container is preferably detachably mountable onto a pump unit, the pump unit comprising a fluid inlet element configured to be connectable to the container preferably via to the outlet of the container.

Preferably means is provided to adjust the flow rate of the nutritional substance being delivered to the delivery tube via the outlet. Preferably the means to adjust the flow rate is provided by flow controller for the pump.

It should be appreciated that embodiments and aspects of the invention are suitable or adaptable for other types of assemblies and devices for delivering a flowable nutritional substance.

According to a fourth aspect of the invention there is provided a method, for delivering a flowable nutritional substance to a delivery tube, comprising the following steps:

a) placing at least one nutritional substance in a container comprising an open end and a fluid outlet,

b) placing a closure into the open end of the container so forming an enclosed inner region within the container,

c) applying pressure to the closure so as to expel a gas from inner region of the container through a unidirectional valve, and

d) extracting the nutritional substance via the outlet using a fluid pump to reduce the pressure in the container.

The nutritional substance is preferably a flowable substance. However, in an embodiment of the fourth aspect of the invention there is provided an additional step following the above mentioned step a), wherein the additional step comprises:
ai) mixing and/or blending the nutritional substance in the container to form a flowable substance.

Preferably the speed or flow rate of the nutritional substance extraction is controllable and preferably the flow rate is controllable by adjusting a pump.

According to an embodiments of the fourth aspect of the invention there is provided a method, for delivering a flowable nutritional substance to a delivery tube, comprising the following steps:

a) placing at least one nutritional substance in a container comprising an open end and a fluid outlet,

b) placing a closure into the open end of the container so forming an enclosed inner region within the container,

c) extracting the nutritional substance via the outlet using a fluid pump to reduce the pressure in the container,

d) removing the closure from the container, and

e) repeating steps a) to c)

In a further embodiment of the fourth aspect of the invention there is provided a further step comprising placing the container on a surface.

The dependent claims are concerned with advantageous variations of the invention.

It should be appreciated that one or more of the invention embodiments and aspects may also comprise one, or a combination of, the elements described herein with reference to the drawings.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The aspects and embodiments of the present invention will now be described in more detail in relation to the enclosed drawings, as non-limiting examples only, in which:

FIG. 1 is a side view of an embodiment of an assembly for delivering a flowable nutritional substance,

FIG. 2 is a partial cross-sectional side view of the assembly shown in FIG. 1,

FIG. 3 is a partial cross-sectional side view of the middle section of assembly shown in FIG. 1,

FIG. 4 is a partial cross-sectional side view of the upper section of assembly shown in FIG. 1,

FIG. 5 is a schematic showing the use of assembly shown in FIG. 1, and

FIG. 6 is a series of six schematic drawings showing the use of assembly shown in FIG. 1.

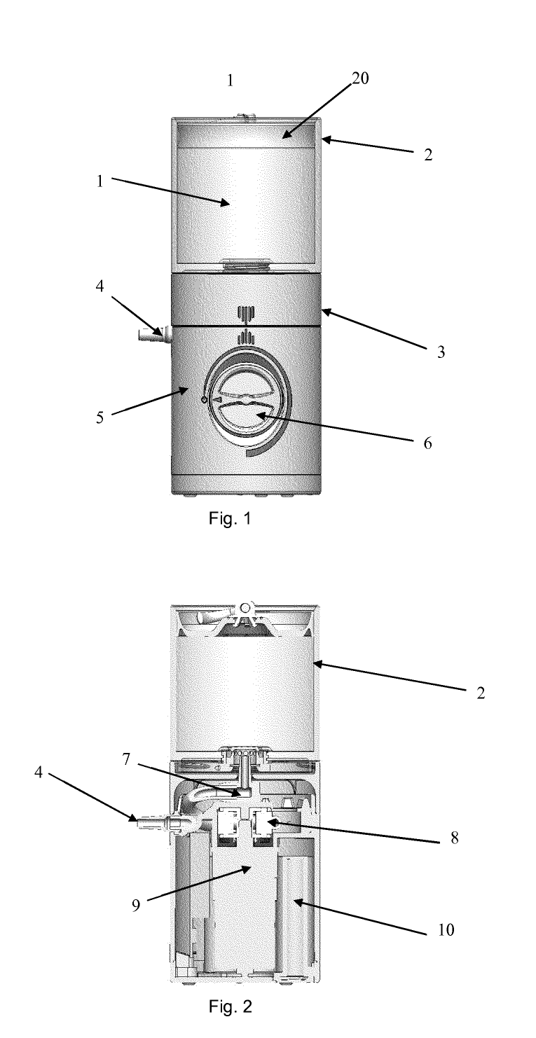

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices and methods are omitted so as not to obscure the description of the invention with unnecessary detail. While the invention has been described in connection with what is presently considered to be most practical and preferred embodiments, it is to be understood that the invention is not to be limited to the disclosed embodiments, but on the contrary, is intended to cover various modifications and equivalent arrangements.

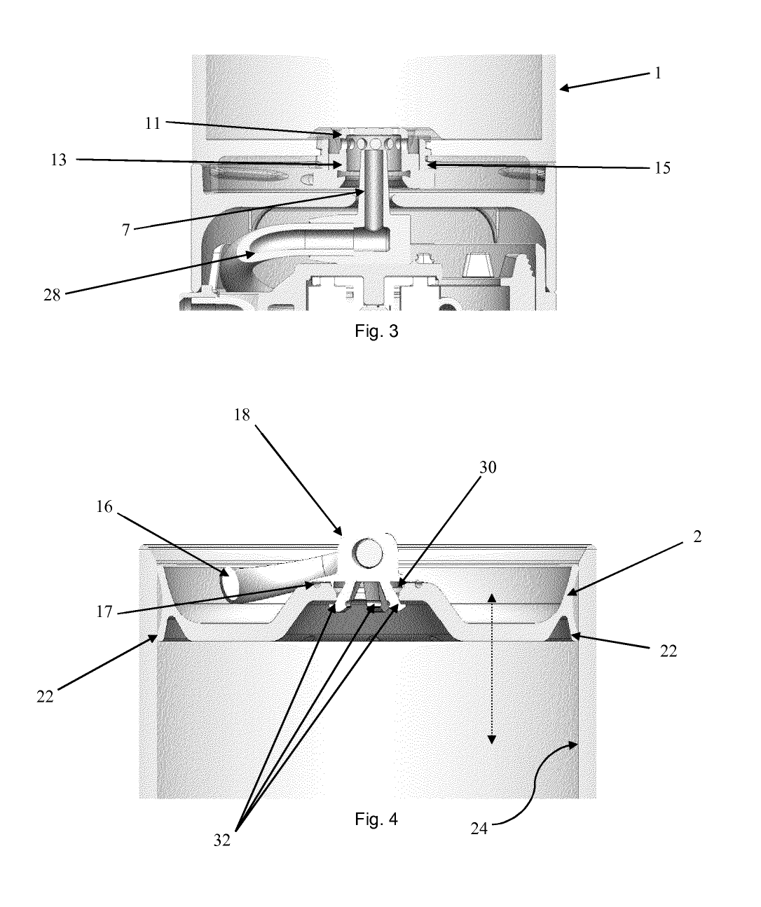

With reference to the Figures there is shown an example of an assembly for delivering a flowable nutritional substance comprises a substantially tubular container 1 formed with enclosed lower end and an open upper end, the open upper end being adapted to receive in a sealing manner a closure 20, the closure comprising a unidirectional valve 18, preferably disposed in or near its axial center; other placements are possible e.g. based on design considerations. The container 1 comprising a fluid outlet port in the form of a valve 13 (see FIG. 3), a pump mechanism 3 is contained in a pump housing 5.

The pump mechanism 3 is suitably connected to the pump housing 5. The closure 2 provides some protection to the substance held in the container. In the embodiment shown the closure 2 is in the form of a disc-like piston or plunger which is slidably moveable within the container 1. The closure piston 2 has at its outer circumference an annular lip 22 that forms a seal against the inner wall surface 24 of the container 1. The closure piston 2 can be moved up and down along the inner wall surface 24 of the container 1 either by applying a manual force, for example by the user, or by a negative pressure created by the operation of the pump mechanism 3 and the negative pressure being formed on the inner underside of the piston 2.

A tube 26 (see FIG. 5), which transfers nutritional substance via the pump mechanism 8 to the person eating, is connected to the assembly via a barbed connector 4. The pump mechanism 3 is operated through a user interface in the form of a turnable dial 6 by which the user can turn the system on and off, select a desired flow rate by adjusting the speed of the pump mechanism 3.

In the cross section in FIG. 2 there is shown how the assembly provides means to transport nutrition substance from the inner volume of the container 1 through a hose 28 and a substantially “L-shaped” tubular connection 7, around a rotor (not shown) in the pump mechanism 8 by which a pressure is applied to the nutrition substance. The rotor is connected to suitable electric motor 9. Electric energy is used to drive the motor 9 and can be supplied for example by an AC adapter (not shown) or internal batteries 10.

In FIG. 3 it is shown how a valve in the tank 13 is penetrated by hose couplings 7 so that when the valve opens nutrition may flow into the tube. The valve is attached to a threaded sleeve 15. A sieve arrangement 11 is located at the lower region of the container 1. The sieve arrangement 11 is a perforated up-turned cup shape and is used to screen out any large particles from the nutrition substance as the substance flows out of the container 1. The sieve arrangement 11 is clamped between an annular shaped threaded sleeve 15 and the container 1. The sleeve 15 can be unscrewed out of the container 1 so both valve 13 and sieve 11 can be taken out and cleaned or replaced.

There are generally two types of tube sizes in being use for the delivery of nutritional substances. The larger of these has an inner diameter of about 4 mm, but standard tubing may have an inner diameter of down to about 1 mm. Therefore, the sieve 11 should have an opening adapted to help ensure that particles of a certain size do not pass into the respective tubes and become stuck so causing a blockage, for example particles of approximate diameter of 1.5 mm require a tube diameter of about 1.8 mm. The skilled person will appreciate that other factors, such as substance viscosity or composition will also have an effect on the choice of optimum diameter of tubes.

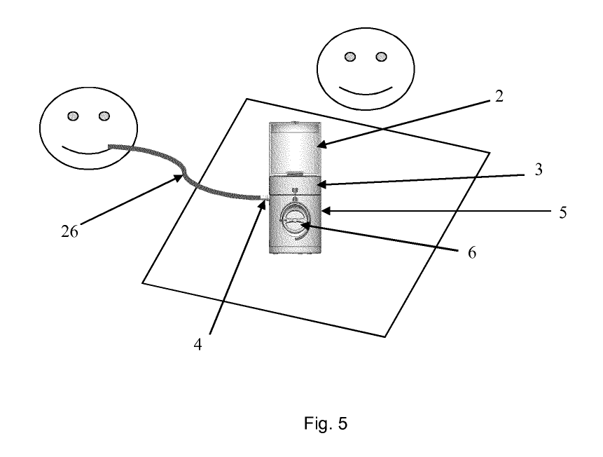

In FIG. 4 it is shown how the piston 2 is designed so that the outer diameter forms a flexible lip 22 that forms a sealing contact with the inner wall surface 24 of the container. The closure piston 2 is formed with a substantially circular central hole 30. Disposed partially within the hole 30 is a one-way valve 18 element formed with a plurality of resilient locking legs 32 and an annular sealing gasket 17. The locking legs 32 are designed to extend through the hole 30 and attach to the underside of the closure 2 so retaining the valve 18 onto the closure piston 2 such that upper side of the respective distal ends of the legs 32 abut the underside of the closure piston 2 and forms a spring force against the piston 2. The one-way valve 18 is controllable between an operable condition where in fluid can only pass from inside the container 1 to outside the container 1 via the valve 18 and an inoperable condition where in fluid may flow in both directions into and out of the container 1. The inoperable condition may be achieved by extracting the legs 32 from the hole 30 and removing the valve 18 from the closure 2. The removal may be assisted, for example, by use of a leverage handle 16.

Example of the Use the Procedure

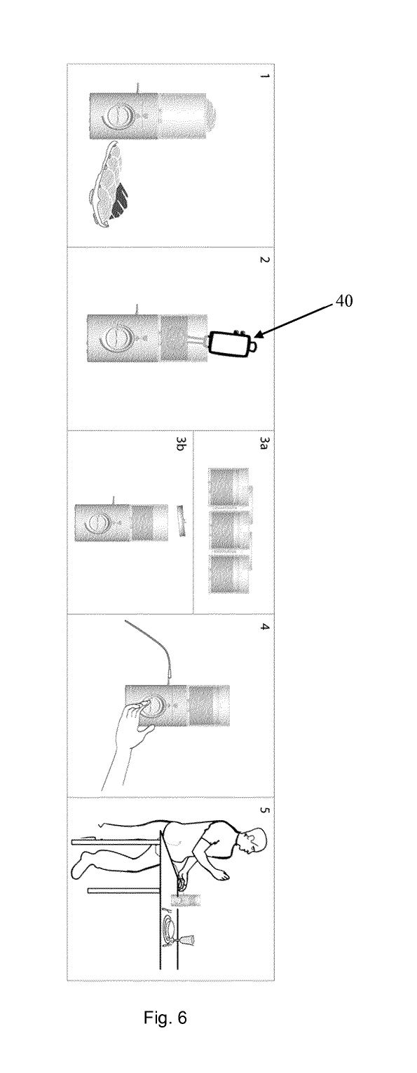

To give a better understanding of the process of the invention, there is given in the following an exemplary description of a typical use of the assembly shown the Figures. The description given with reference to the drawings, in which, FIG. 5 shows two participants at a meal and FIG. 6 shows five steps for the preparation of a meal.

The inventive method allows for the preparation and storage, combined with a suitable feeding solution for home cooking. The preparation of home-cooked food includes several sub-processes that allow a typical meal comprising several courses for patients needing enteral feeding.

Other useful information may be provided for the user such as:
Written, or in a multimedia format, guidelines are provided for the preparation of nutrition through the use of the invention, the selection of ingredients and recipes. The guidelines describe how the ingredients shall be combined and treated to give a good result with the invention.
Nutritional analysis of the various dishes based on ingredients. For that user who needs help with simple nutritional calculations this is made possible by an accurate nutritional analysis based on the ingredients used. Nutrition reviews in this analysis are used in relation to, for example, weight gain, nutritional composition and other adjustments.
Process for the preparation of food with the desired qualities. This method intends to use the meal as it is normally cooked. Dishes having a thicker consistency or dishes with larger bits of a defined size require a somewhat extended preparation. The food's thickness may be reduced by adding water and dishes with larger pieces and bits may be reduced using a hand blender.
Storage of the meals. The storage of portions, if needed, in containers placed in line before the meal. The containers are suitable for storing in the refrigerator and at room temperature for a limited time range, as well as freezing and thawing and heating in the microwave.
Thawing or heating at mealtimes. The portions are heated in the containers in a microwave or in a water bath.
Distribution at mealtimes. Food portions in the container on the pump where a mechanical device manages the food from the container into a thin tube and the user. The mechanical device has several features that provide a safe food distribution and a good user experience in terms of aesthetics and function.
Cleaning and Container Storage. It is easily cleaned din a dishwasher. The tubes that are in contact with the food are discarded and replaced with new ones.

An empty serving container 1 can be use directly with a bowl or a glass at the table location. This ensures a meal experience which is less stigmatised and much closer to a normal meal experience, as shown in FIG. 5. This shows schematically a meal procedure in which the invention is used for a person with a probe in the esophagus. His second will be served. The one-way valve on the container on the table is released, the container 1 is opened and new foods are added into the container 1. If consistency of this is coarse, then the consistency may be improved by using a hand blender, or being mashed out with a fork and if necessary adding some extra fluid. The container 1 is closed by placing the closure piston 2 into the top open end of the container 1. The closure piston 2 is pushed down until the rim 22 comes in contact with the food substance. Any unwanted air in the container is purged from the container 1 via the valve 18 as the closure is pushed down. It will be appreciated that a purge valve could also be located in the upper portion of the wall section of the container 1.

The tube 26 is connected to the assembly and the user is ready to eat. The pump mechanism 3 is started, and volume flow rate of the nutritional substance may be adjusted using the dial 6. By such a method all participants at the meal have the same experience. Smell, temperature and consistency can be experienced by all, even colour as parts of assembly may be transparent.

FIG. 6 shows typical method steps:
FIG. 6.1: Food placed beside and in the container 1 is the same type of food as the other participants will eat.
FIG. 6.2: If the food is too course then a hand blender 40 is used to the body of food until the food substantially consists of particles with a size that can pass the sieve 11. If necessary also adding liquid, for example the same liquid as the other participants drink.

FIG. 6.3a: In an alternative assembly there may be provided several different containers each being prepared in advance and being ready with various dishes and drinks. In this way food is served at the same time as the other participants at the meal. Also food can be served from larger containers or barrels and be prepared as desired, along with drinks.
FIG. 6.3b: One of the containers is taken and is placed on the pump unit 3 and a closure 2 is placed into the container 1.
FIG. 6.4: The pump unit 3 with a container 1 is placed on the table and the tube 26 is connected from the port 4 to the mouth or nose of the person in readiness to eat. The pump 3 is started and volume flow in the tubing is regulated on the pump unit.
FIG. 6.5: The meal can begin. Container 1 can be replaced or the steps in FIG. 6 can be repeated thereafter.

It should be realized by the skilled person in the art, that the present invention provides the means where the user can refill the container 1 at any time during the meal. The removable closure allows for repeated access to the container either while the pump 3 is stopped or alternatively while the pump is operational and there is nutritional substance being delivered to the user.

The container 1 may alternatively be designed as a bag or a flexible container where air can be squeezed out or which also has a one-way valve. The inventive assembly may be designed to accept both types of containers.

The process of using the assembly may also comprises one or more of the following steps:
a) In the said container, preparing, including thawed or warm up food or drink, or pouring finished food or nutrition in this, or retrieving such pre-filled container from storage,
b) Placing a closure with lips in the container,
c) Placing the container on the pump unit,
d) Placing the pump unit with the container on a dining table or similar,
e) Connecting a tube to a pump unit and bringing the tube to the stoma opening, port, mouth or nose of the person who shall eat,
f) Starting the pump and regulating the flow in the tube, and
g) When a new course is served this is added to the container by releasing the one-way valve, pulling up the piston and either placing further nutrition in the container, or fitting a secondary container inside the container and connecting to the container, or replacing the container with a new container.

By use of the invention including the above steps different courses can be served one after another. This process gives the user full freedom to take part in meals in an inclusive way.

1. An assembly for delivering a flowable nutritional substance to a delivery tube, the system comprising:
a container, the container including an outlet for the nutritional substance;
a closure for the container, the closure including a unidirectional valve configured to purge fluid from the container; and
a pump, the assembly being arranged such that in use the pump is configured to transfer the nutritional substance from the container to the delivery tube via the outlet.

2. The assembly according to claim 1, wherein the unidirectional valve has an operative condition, such that in the operative condition fluid is only passable through the valve in a directional flow from inside the container to outside the container.

3. The assembly according to claim 2, wherein the unidirectional valve has an inoperative condition such that in said inoperative condition fluid may flow in both directions into and out of the container.

4. The assembly according to claim 3, wherein the inoperative condition is achieved by providing means to at least partially open the valve in the closure.

5. The assembly according to claim 4, wherein the at least partial removal of the closure including the valve provides access to the inner parts of the container whereby the container may be filled with at least one of the flowable nutritional substance and a non-flowable nutritional substance.

6. The assembly according to claim 1, wherein the unidirectional valve for purging fluid from the container is formed in the container wall or is received by a port formed in the container wall.

7. The assembly according to claim 1, wherein the container is formed with an open end and the closure being adapted to be received by the open end.

8. The assembly according to claim 1, wherein in use the closure forms a sealable contact with an inner surface of the container when the closure is received by the open end.

9. An assembly for delivering a flowable nutritional substance to a delivery tube, the assembly comprising:
a container, the container including an outlet for a nutritional substance;
a closure for the container; and
a pump, the assembly being arranged such that in use the pump is configured to transfer the flowable nutritional substance from the container to the delivery tube via the outlet, wherein the closure is a movable piston being capable of slidable contact with a surface of the container.

10. The assembly according to claim 9, wherein the closure comprises an annular seal that is in slidable contact with an inner surface of the container.

11. The assembly according to claim 9, wherein the annular seal is a flexible radially arranged outer rim.

12. The assembly according to claim 9, wherein the assembly is arranged such that in use the closure moves relative to the container surface in response to a pressure difference between an outer portion of the closure and an inner portion of the closure.

13. The assembly according to claim 12, wherein the pressure difference experienced by the closure is generated by the pump transferring the nutritional substance from the container.

14. The assembly according to claim 12, the movement of the closure is in a direction towards the outlet for the nutritional substance.

15. The assembly according to claim 12, wherein the movement of the closure is in a direction towards the pump.

16. The assembly according to claim 12, wherein in use the movement of the closure is in a direction away from the open end of the container.

17. The assembly according to claim 12, wherein in use the movement of the closure is in a direction substantially downward and towards a surface supporting at least one of the container, the closure and/or pump unit rest.

18. An assembly for delivering a flowable nutritional substance to a delivery tube according to claim 1, wherein the assembly comprises means for filtering the nutritional substance prior to the nutritional substance entering the delivery tube.

19. The assembly according to claim 18, wherein the filtering means comprises at least one flow restriction formed to prevent passage of particles of a predetermined size and allow passage of other matter formed from particles of sizes lesser than the said predetermined size.

20. The assembly according to claim 18, wherein the filter means comprises a plurality of flow restrictions formed by a number of orifices and/or being formed by a mesh structure.

21. The assembly according to claim 20, wherein the orifices and/or mesh structure have an opening size of greater than or equal to 1 mm.

22. The assembly according to claim 19, wherein the orifices and/or mesh structure have an opening size of less than or equal to 4 mm.

23. The assembly according to claim 19, wherein the orifices and/or mesh structure have an opening size in the range of between 1 mm and 4 mm (inclusive).

24. The assembly according to claim 19, wherein the filtering means is disposed adjacent the outlet of the container in the flow path of the nutritional substance.

25. The assembly according to claim 1, wherein the container is detachably mountable onto a pump unit, the pump unit comprising a fluid inlet element configured to be connectable to the container preferably via to the outlet of the container.

26. The assembly according to claim 1, further comprising a user interface to adjust the flow rate of the nutritional substance being delivered to the delivery tube via the outlet.

27. The assembly according to claim 26, wherein the user interface is a turnable dial in communication with the pump.

28. A method for delivering a flowable nutritional substance to a delivery tube, comprising the following steps:
a) placing at least one nutritional substance in a container comprising an open end and a fluid outlet;
b) placing a closure into the open end of the container so forming an enclosed inner region within the container;
c) applying pressure to the closure so as to expel a gas from inner region of the container through a unidirectional valve; and
d) extracting the nutritional substance via the outlet using a fluid pump to reduce the pressure in the container.

29. The method according to claim 28, further comprising an additional step following step a), wherein the additional step comprises:
ai) mixing and/or blending the nutritional substance in the container to form a flowable substance.

30. The method according to claim 28, wherein the speed or flow rate of the nutritional substance extraction is controllable by adjusting a pump.

31. A method for delivering a flowable nutritional substance to a delivery tube, comprising:
a) placing at least one nutritional substance in a container comprising an open end and a fluid outlet;
b) placing a closure into the open end of the container so forming an enclosed inner region within the container;
c) extracting the nutritional substance via the outlet using a fluid pump to reduce the pressure in the container;
d) removing the closure from the container; and
e) repeating steps a) to c).

32. The method according to claim 28, further comprising placing the container on a surface.

33. (canceled)

34. (canceled)

35. (canceled)
